(19) United States
(12) Patent Application Publication
(10) Pub. No.: US 2018/0310329 A1
(43) Pub. Date: Oct. 25, 2018

(54) Apparatus and Method for Random Access and Data Transmission and Communication System

(71) Applicant: FUJITSU LIMITED, Kawasaki-shi (JP)

(72) Inventors: Xianjun YANG, Beijing (CN); Xin WANG, Beijing (CN); Jian ZHANG, Beijing (CN)

(73) Assignee: FUJITSU LIMITED, Kawasaki-shi (JP)

(21) Appl. No.: 16/018,928

(22) Filed: Jun. 26, 2018

Related U.S. Application Data
(63) Continuation of application No. PCT/CN2016/071744, filed on Jan. 22, 2016.

(51) Int. Cl. H04W 72/12; H04W 4/70; H04W 74/08; H04W 72/02; H04L 1/16

(52) U.S. Cl. CPC H04W 72/1268; H04W 4/70; H04L 1/1607; H04W 72/02; H04W 74/0833

(57) ABSTRACT

An apparatus and method for random access and data transmission and a communication system. The method includes: generating data information used for both random access and data transmission by a UE, the data information including a UE ID, data to be transmitted and a pilot signal; selecting one or more resource block for transmitting the data information from predetermined resources; and mapping the data information onto the resource blocks and transmitting the data information. Hence, random access and data transmission can be achieved in one step, which can both lower signaling overhead and increase the number of accessed UEs.

### CROSS REFERENCE TO RELATED APPLICATIONS

This application is a continuation application of International Application PCT/CN2016/071744 filed on Jan. 22, 2016, the entire contents of which are incorporated herein by reference.

### TECHNICAL FIELD

This disclosure relates to the field of communication technologies, and in particular to an apparatus and method for random access and data transmission and a communication system.

### BACKGROUND

One of the three main usage scenarios of the five generation (5G) defined by the International Telecommunication Union (ITU) is massive machine type communications, which is characterized by a huge number of connected devices with infrequent and non-delay-sensitive small data transmission.

However, current 4G system is designed for high data rate and high quality requirement communications for human. One of the biggest problems of using 4G system for the massive machine type communications is that when each user equipment (UE) in an idle state needs to transmit an infrequently-transmitted packet, a complicated four-step random access (RA) procedure needs to be performed.

FIG. 1 is a schematic diagram of a current random access procedure, in which a contention-based case is shown.

As shown in FIG. 1, the random access procedure includes four steps:

step 1: generating a random access preamble by a UE, and transmitting the random access preamble on a physical random access channel (PRACH) to a base station, the random access preamble carrying bit-information indicating L2/L3 messages;

step 2: transmitting an RA response (RAR) by the base station on a physical downlink shared channel (PDSCH), the RAR including a random access radio network temporary identifier (RA-RNTI), and uplink grants (UL grants) of the L2/L3 messages, etc.;

step 3: transmitting the L2/L3 messages by the UE on a physical uplink shared channel (PUSCH) after receiving the RAR; and

step 4: feeding back a collision solution message by the base station to successfully accessed UE.

It can be seen that overhead of the current random access procedure is large relative to a small packet, and when the number of UEs which want to access the system at the same time becomes large, a probability of collision will be increased significantly.

In order to lower signaling overhead, a connectionless small packet transmission scheme was proposed, in which the four-step random access procedure in the LTE is reduced into three steps: step 1: transmitting enhanced random access channel (RACH) information which carries a UE ID; step 2: performing collision solution and feeding back timing advance (TA) and an RAR; and step 3: transmitting an enhanced message 3 which carries data of the UE. Furthermore, it was proposed in some documents that when a subcarrier spacing is very small and a length of cyclic prefix (CP) is very large, a process of transmitting a random access preamble and a process of feeding back an RAR may be omitted. However, a defect of the above methods is that when the number of UEs which want to access the system at the same time is very large, a probability of collision will be very high.

On the other hand, in order to increase the number of accessing UEs at the same time, a contention based technique called sparse code multiple access (SCMA) was proposed, in which a sparse code and a pilot sequence are used to jointly differentiate UEs. However, the SCMA is designed for synchronized UEs, which means that before performing SCMA communication, a UE in an idle state still needs to perform the four-step random access procedure.

Furthermore, the standardization organization 3GPP (the 3rd Generation Partnership Project) established a new work item about the narrow-band Internet of Things (NB-IoT) at the 69th RAN plenary meeting of Release 13 of the advanced long term evolution (LTE-A) system, so that the LTE is enabled to support access of massive low-rate devices. However, the NB-IoT is aimed at not changing the LTE-A system too much. Hence, in Release 13, the NB-IoT will still reserve the four-step random access procedure of the LTE, thereby signaling overhead is still high.

In summary, in the existing methods, both lowering signaling overhead and increasing the number of accessed UEs cannot be achieved.

It should be noted that the above description of the background is merely provided for clear and complete explanation of this disclosure and for easy understanding by those skilled in the art. And it should not be understood that the above technical solution is known to those skilled in the art as it is described in the background of this disclosure.

Documents advantageous to understanding of this disclosure and conventional technologies are listed below, which are incorporated herein by reference, as they are fully described in this text.
[1] Recommendation ITU-R M.2083-0, “IMT Vision—Framework and overall objectives of the future development of IMT for 2020 and beyond”, September, 2015.
[2] Stefania Sesia, Issam Toufik, Matthew Baker, “LTE—The UMTS Long Term Evolution: From Theory to Practice,” 2nd Edition, Wiley press.
[3] 3GPP TR 23.720, “Architecture enhancements for Cellular Internet of Things”.
[4] “Uplink Contention Based Multiple Access for 5G Cellular IoT”, IEEE VTC-fall, 2015.
[5] “Uplink Contention Based SCMA for 5G Radio Access”, IEEE GloebeCom Workshop, 2014.
[6] 3GPP RP-151621, “New Work Item: NarrowBand IOT (NB-IOT)”.
[7] 3GPPR1-157424, “NB-IoT—Random access design”.
[8] 3GPPR1-156990, “Discussion on Preamble-based RA and Message-based RA for Rel-13 NB-IoT”.
[9] “Regular and Irregular Progressive Edge-Growth”, IEEE Transactions on Information Theory, Vol. 51, No. 1, January 2005.
[10] “Novel Low-Density Signature for Synchronous CDMA Systems Over AWGN Channel”, IEEE Transactions on Signal Processing, Vol. 56, No. 4, April 2008.
[11] Abdoli, J.; Ming Jia; Jianglei Ma, “Filtered OFDM: A new waveform for future wireless systems”, in IEEE 16th International Workshop on Signal Processing Advances in Wireless Communications (SPAWC), pp. 66-70, Jun. 28 2015.

### SUMMARY

Embodiments of this disclosure provide an apparatus and method for random access and data transmission and a communication system, in which random access and data transmission can be achieved in one step, which can both lower signaling overhead and increase the number of accessed UEs.

According to a first aspect of the embodiments of this disclosure, there is provided a method for random access and data transmission, including:

generating data information used for both random access and data transmission by a UE, the data information including a UE ID, data to be transmitted and a pilot signal;

selecting one or more resource blocks for transmitting the data information by the UE from predetermined resources; and

mapping the data information by the UE onto the resource blocks and transmitting the data information.

According to a second aspect of the embodiments of this disclosure, there is provided an apparatus for random access and data transmission, configured in a UE, the apparatus including:

a data generating unit configured to generate data information used for both random access and data transmission, the data information including a UE ID, data to be transmitted and a pilot signal;

a resource selecting unit configured to select one or more resource blocks for transmitting the data information from predetermined resources; and

an information transmitting unit configured to map the data information onto the resource blocks and transmit the data information.

According to a third aspect of the embodiments of this disclosure, there is provided a method for random access and data transmission, including:

receiving, by a base station, data information used for both random access and data transmission transmitted by a UE, the data information including a UE ID, data to be transmitted and a pilot signal;

performing user detection and latency estimation by the base station, to achieve random access of the UE; and

obtaining the data by the base station based on the data information.

According to a fourth aspect of the embodiments of this disclosure, there is provided an apparatus for random access and data transmission, configured in a base station, the apparatus including:

an information receiving unit configured to receive data information used for both random access and data transmission transmitted by a UE, the data information including a UE ID, data to be transmitted and a pilot signal;

a user detecting unit configured to perform user detection and latency estimation, to achieve random access of the UE; and

a data obtaining unit configured to obtain the data based on the data information.

According to a fifth aspect of the embodiments of this disclosure, there is provided a communication system, including:

a UE configured to generate data information used for both random access and data transmission, the data information including a UE ID, data to be transmitted and a pilot signal, select one or more resource blocks for transmitting the data information from predetermined resources, and map the data information into the resource blocks and transmit the data information; and

a base station configured to receive the data information transmitted by the UE, perform user detection and latency estimation to achieve random access of the UE, and obtain the data based on the data information.

An advantage of the embodiments of this disclosure exists in that the UE selects one or more resource blocks for transmitting the data information from predetermined resources, and maps the data information containing a UE ID onto the resource blocks and transmits the data information. Hence, random access and data transmission can be achieved in one step, which can both lower signaling overhead and increase the number of accessed UEs

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram of a current random access procedure;

FIG. 2 is a schematic diagram of the method for random access and data transmission of Embodiment 1 of this disclosure;

FIG. 3 is another schematic diagram of the method for random access and data transmission of Embodiment 1 of this disclosure;

FIG. 4 is a further schematic diagram of the method for random access and data transmission of Embodiment 1 of this disclosure;

FIG. 5 is a schematic diagram of data information of Embodiment 1 of this disclosure;

FIG. 6 is a schematic diagram of the method for random access and data transmission of Embodiment 2 of this disclosure;

FIG. 7 is a schematic diagram of a frame structure using an orthogonal preamble sequence and orthogonal resource mapping of Embodiment 3 of this disclosure;

FIG. 8 is a schematic diagram of time frequency resource mapping of the preamble sequence of Embodiment 3 of this disclosure;

FIG. 9 is a schematic diagram of a frame structure using an orthogonal preamble sequence and nonorthogonal resource mapping of Embodiment 4 of this disclosure;

FIG. 10 is a schematic diagram of a frame structure using a nonorthogonal preamble sequence and orthogonal resource mapping of Embodiment 5 of this disclosure;

FIG. 11 is a schematic diagram of a frame structure using a nonorthogonal preamble sequence and nonorthogonal resource mapping of Embodiment 6 of this disclosure;

FIG. 12 is a schematic diagram of a frame structure not using a preamble sequence and using orthogonal resource mapping of Embodiment 7 of this disclosure;

FIG. 13 is a schematic diagram of a frame structure not using a preamble sequence and using nonorthogonal resource mapping of Embodiment 8 of this disclosure;

FIG. 14 is a schematic diagram of the apparatus for random access and data transmission of Embodiment 9 of this disclosure;

FIG. 15 is another schematic diagram of the apparatus for random access and data transmission of Embodiment 9 of this disclosure;

FIG. 16 is a schematic diagram of the UE of Embodiment 9 of this disclosure;

FIG. 17 is a schematic diagram of the apparatus for random access and data transmission of Embodiment 10 of this disclosure;

FIG. 18 is another schematic diagram of the apparatus for random access and data transmission of Embodiment 10 of this disclosure;

FIG. 19 is a schematic diagram of a base station of Embodiment 10 of this disclosure; and

FIG. 20 is a schematic diagram of the communication system of Embodiment 11 of this disclosure.

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of the present disclosure, a base station may be referred to as an access point, a broadcast transmitter, a node B, or an evolution node B (eNB), etc., and may include some or all functions of them. A term “base station” shall be used in the text, and each base station provides communication coverage for a specific geographical region. A term “cell” may refer to a base station and/or a coverage region thereof, depending on the context using the term.

In the embodiments of the present disclosure, a mobile station or equipment may be referred to as a user equipment (UE). The UE may be fixed or mobile, and may also be referred to as a mobile station, a terminal, an access terminal, a user unit, or a station, etc. The UE may be a cellular phone, a personal digital assistant (PDA), a wireless modem, a wireless communication device, a handhold device, a lap-top computer, and a cordless telephone, etc.

### Embodiment 1

The embodiment of the present disclosure provides a method for random access and data transmission, which shall be described from a UE side.

FIG. 2 is a schematic diagram of the method for random access and data transmission of the embodiment of this disclosure. As shown in FIG. 2, the method includes:

Block 201: a UE generates data information used for both random access and data transmission, the data information including a UE ID, data to be transmitted and a pilot signal.

Block 202: the UE selects one or more resource blocks for transmitting the data information from predetermined resources; and

Block 203: the UE maps the data information onto the resource blocks and transmits the data information.

In this embodiment, the UE may be a machine type communication (MTC) terminal in an IoT system, and performs a random access and data transmission procedures to a base station (such as an eNB) of the IoT system. However, this disclosure is not limited thereto; for example, other communication systems may also be used, that is, the embodiments of this disclosure are described by taking an IoT system and/or a MTC UE as examples only. However, this disclosure is not limited thereto, and it is also applicable to any communication systems performing random access and data transmission.

In this embodiment, the base station may be a macro base station (such as an eNB), and one or more macro cells generated by the macro base station may serve for the UE; or the base station may also be a pico base station, and one or more pico cells generated by the pico base station may serve for the UE. However, this disclosure is not limited thereto, and a particular scenario may be determined according to an actual situation.

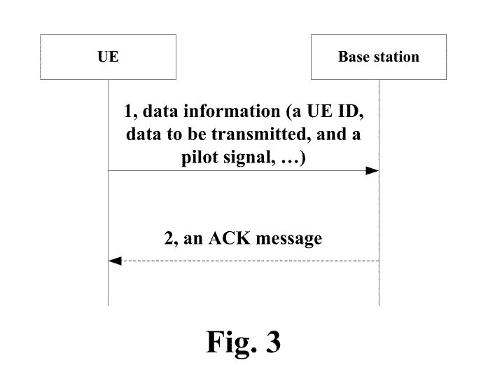

FIG. 3 is another schematic diagram of the method for random access and data transmission of the embodiment of this disclosure, in which interaction between the UE and the base station is shown from the UE side and the base station side.

As shown in FIG. 3, each UE may randomly select one or more resource blocks from predefined resources, such as obtaining a transmission resource by contention, and then may transmit the data information via a PUSCH. And furthermore, in order to reduce inter-UE interference resulted from asynchronization of the UEs, a filtered orthogonal frequency division multiplexing (f-OFDM) technique may be adopted to perform multicarrier modulation on the data. Hence, the data information including the UE ID, the data to be transmitted and the pilot signal is transmitted to the base station in one step, and massive UEs can be supported.

Furthermore, after correctly decoding the transmitted data, the base station may transmit an acknowledgement (ACK) message to the UE. And if the UE does not receive the ACK message within a predefined time period, it may be randomly back off for a period of time, and then retransmit the data information.

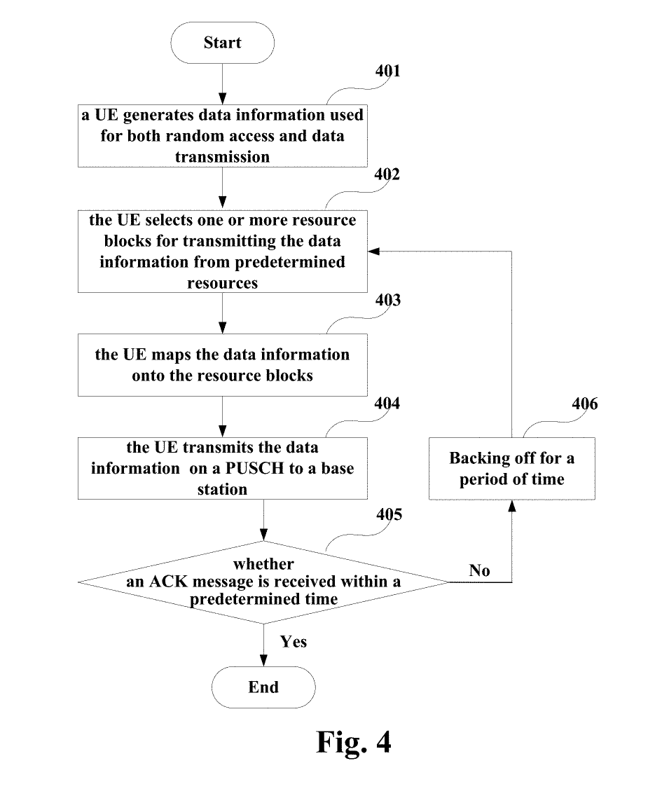

FIG. 4 is a further schematic diagram of the method for random access and data transmission of the embodiment of this disclosure, which shall be described from the UE side. As shown in FIG. 4, the method includes: Block 401: a UE generates data information used for both random access and data transmission;

the data information at least includes a UE ID, data to be transmitted and a pilot signal.

Block 402: the UE selects one or more resource blocks for transmitting the data information from predetermined resources.

Block 403: the UE maps the data information onto the resource blocks.

Block 404: the UE transmits the data information on a PUSCH to the base station.

Block 405: the UE determines whether an acknowledgement (ACK) message fed back by the base station is received within a predetermined time, terminating this time of random access and data transmission procedures if the ACK message is received, and executing block 406 if the ACK message is not received in the predefined time period; and

Block 406: the UE backs off for a period of time.

Then the UE executes block 402 again to reselect one or more resource blocks and transmit the data information.

It should be noted that FIG. 4 only schematically explains the embodiment of this disclosure; however, this disclosure is not limited thereto. For example, an order of execution of the blocks or steps may be appropriately adjusted, and furthermore, some other blocks or steps may be added, or some of these blocks or steps may be reduced. And appropriate modifications may be made by those skilled in the art according to what is described above, without being limited to those contained in the above figure.

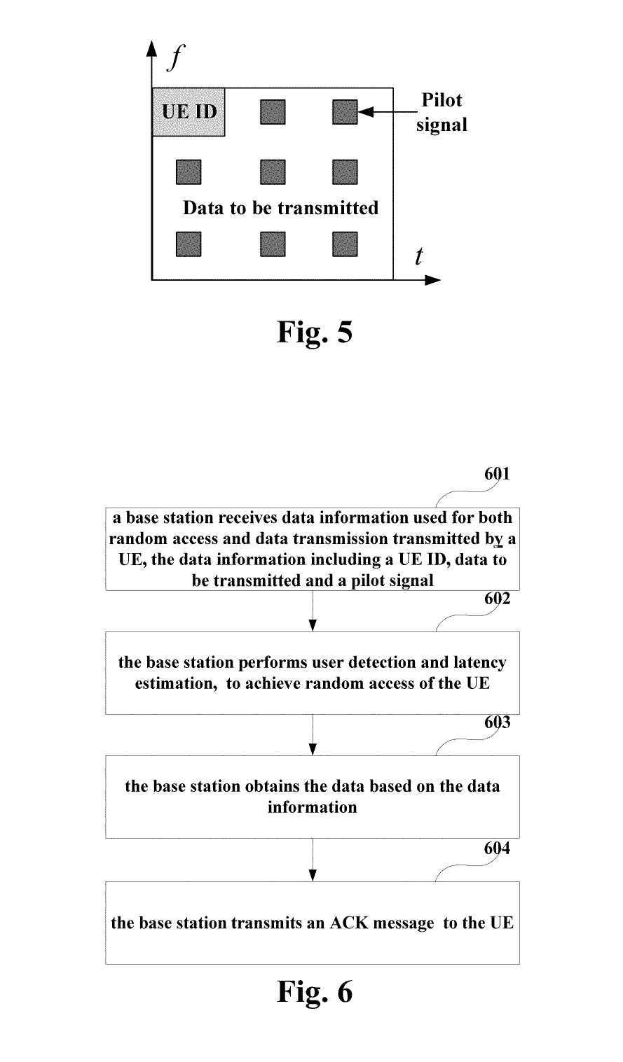

FIG. 5 is a schematic diagram of the data information of the embodiment of this disclosure. As shown in FIG. 5, the data information may at least include the UE ID, the data to be transmitted (which may also be referred to as a payload) and the pilot signal. The UE ID may be an ID allocated when the UE establishes traffic connection (such as performing a UE registration or establishing a security key, etc.) with the base station, such as an RA-RNTI, etc.; however, this disclosure is not limited thereto.

Different from the conventional four-step random access procedure, in the embodiment of this disclosure, a UE ID is contained in the data information and the data information is transmitted by using the randomly selected resource block. Hence, such processes as RAR feedback, etc., are not needed, and random access and data transmission can be achieved in one step.

In this embodiment, a pilot position and a pilot sequence of the pilot signal may be predetermined.

For example, the UE may transmit a predefined pilot sequence at a time frequency resource position agreed between the UE and the base station.

Alternatively, the time-frequency position and the pilot sequence for the pilot signal may not be predetermined, and the UE may randomly select a time-frequency position and a pilot sequence for the pilot signal. Hence, an effect of collision resulted from selecting the same resource block (hereinafter referred to as an mRB) by different UEs on demodulation performance may be reduced.

For example, each UE may randomly select a time-frequency position and a pilot sequence for transmission of a pilot signal from a predetermined time-frequency position set and a pilot sequence set. After receiving the data information, the base station may perform channel estimation at all possible pilot positions using all possible pilot sequences, and if amplitudes of channel estimation results are not differ much in the frequency domain and sparsity is presented in the time domain, it may be determined that a UE transmits a pilot sequence at the pilot position and data at the corresponding time-frequency position; otherwise, it is deemed that the pilot sequence and data are not transmitted by a UE at the pilot position and corresponding time-frequency resource.

In one implementation, the UE may further transmit a random access preamble (such as on a PRACH), the random access preamble being used for synchronization and indicating a resource position for transmitting the data information. The random access preamble is, for example, a Zadoff-Chu (ZC) sequence.

For example, a UE may select a random access preamble sequence (or, referred to as a preamble sequence) from a predefined random access preamble sequence set (preamble set), the random access preamble sequence can be used for synchronization and user detection; and the UE may transmit the data information at a resource position indicated by the random access preamble sequence.

In this implementation, random access preamble sequences are mapped to multiple resource blocks, the resource blocks include N_{t,p} symbols in the time domain and N_{f,p} subcarriers in the frequency domain; where, both N_{t,p} and N_{f,p} are positive integers, and N_{t,p} is greater than N_{f,p}. And furthermore, data and random access preambles of multiple UEs occupy the same symbols in the time domain.

For example, taking that mMTC UE is insensitive to latency into account, the random access preamble sequence may be mapped onto an elongated resource block; wherein, N_{t,p} symbols are included in a time dimension, and N_{f,p} subcarriers are included in a frequency dimension, N_{t,p} being much greater than N_{f,p}.

Furthermore, a size of a resource block (mRB) applicable to the mMTC may be determined according a payload of the UE, a pilot density and a size of the UE ID. It is assumed that each mRB contains N_{t,d} symbols in the time dimension and N_{f,d} subcarriers in the frequency dimension, assuming that N_{t,p}=KₜN_{t,d}, in the time dimension, Kₜ mRBs may be carried within the N_{f,d} subcarriers within a time when a random access preamble sequence is transmitted; and in the frequency dimension, ½k_{f}N_{f,d} subcarriers are reserved respectively within upper and lower frequency ranges of the resource blocks occupied by the random access preamble sequence, and within a symbol length, K_{f} mRBs may be carried.

In an implementation, random access preambles may be orthogonal to each other, that is, preamble sequences in a predefined random access preamble sequence set are orthogonal to each other, and each UE may randomly select a preamble sequence from the random access preamble sequence set to transmit.

In another implementation, random access preambles may not be orthogonal to each other, and the random access preambles not orthogonal to each other may be formed by combining multiple orthogonal random access preambles.

For example, a set of nonorthogonal random access preamble sequences is constituted by m orthogonal sequence sets independent of each other, each orthogonal sequence set contains M orthogonal sequences. And the UE may select an orthogonal sequence respectively from the m sets, and the m orthogonal sequences jointly identify a UE (or correspond to a resource block). Hence, the set of nonorthogonal random access preamble sequences may at most identify M^{m} UEs (or correspond to M^{m} resource blocks).

In an implementation, different resource blocks may be orthogonal to each other. For example, each UE occupies different mRBs, and in a case of the above resource division, the orthogonal mapping may carry KₜK_{f} mMTC UEs.

In another implementation, different resource blocks may not be orthogonal to each other, and data information of different UEs is spread and is distributed in a nonorthogonal sparse mode.

For example, data of each UE are spread onto KₜK_{f} mRBs by kₜk_{f}×1 sparse codes; the number of non-zero elements in each sparse code is k, that is, data of each UE are spread onto k mRBs, and there are totally L sparse codewords. In comparison with non-sparse orthogonal spread codes, sparse code spreading may support more UEs; and an overload factor is

$$γ = \frac{L}{{k}_{t} {k}_{f}} ;$$

where, a value of γ may usually be taken from 1.5 to 3.

Transmitting the random access preamble sequences by the UE and detecting the random access preamble sequences by the base station are schematically described above, in which use of the orthogonal preamble sequence, the orthogonal resource mapping, the nonorthogonal preamble sequence and the nonorthogonal resource mapping are illustrated, and reference may be made to the following embodiments for details.

In another implementation, a symbol length and/or a cyclic prefix in the resource block are/is greater than predefined values/a predefined value, so that the base station obtains the transmitted data in predetermined resource blocks by blind detection.

For example, a subcarrier spacing of the UE is very small and lengths of a symbol and a CP are very large and are sufficient to cover roundtrip latency of all UEs within a radius of a cell, the UE may not transmit the random access preamble sequence. At this moment, a guard interval (GT) may be added to a rear end of a symbol temporally neighboring a next mRB, which is used to reduce inter-UE interference on the neighboring mRB resulted from asynchronization. And the base station directly demodulates the data within a predetermined observation time window, corresponding to blindly detecting the UE by demodulating the data.

The orthogonal resource mapping or the nonorthogonal resource mapping may be used, and reference may be made to the following embodiments for details.

It can be seen from the above embodiment that the UE selects one or more resource blocks for transmitting the data information from predetermined resources, and maps the data information containing a UE ID onto the resource blocks and transmits the data information. Hence, random access and data transmission can be achieved in one step, which can both lower signaling overhead and increase the number of accessed UEs.

### Embodiment 2

The embodiment of the present disclosure provides a method for random access and data transmission, which shall be described from a base station side, with contents identical to those in Embodiment 1 being not going to be described herein any further.

FIG. 6 is a schematic diagram of the method for random access and data transmission of the embodiment of this disclosure. As shown in FIG. 6, the method includes:

Block 601: a base station receives data information used for both random access and data transmission transmitted by a UE, the data information including a UE ID, data to be transmitted and a pilot signal.

Block 602: the base station performs user detection and latency estimation, to achieve random access of the UE; and

Block 603: the base station obtains the databased on the data information.

In this embodiment, as shown in FIG. 6, the method may further include:

Block 604: the base station transmits an acknowledgement message to the UE.

Furthermore, if block 603 fails (that is, the base station does not correctly demodulate the data of the UE), the base station may not transmit the ACK message to the UE, and needs not to notify the UE.

In one implementation, the base station further receives a random access preamble transmitted by the UE, the random access preamble being used for synchronization and indicating a resource position for transmitting the data information. The random access preamble is transmitted on a PRACH, and the data information is transmitted on a PUSCH.

In this implementation, the data and the random access preambles of multiple UEs may occupy the same symbols in the time domain. And furthermore, random access preamble sequences are mapped to multiple resource blocks and the resource blocks include N_{t,p} symbols in the time domain and N_{f,p} subcarriers in the frequency domain; where, both N_{t,p} and N_{f,p} are positive integers, and N_{t,p} is greater than N_{f,p}.

In this implementation, the base station performs user detection and latency estimation according to the random access preamble, obtains a resource position of the UE for transmitting the data information based on the detected random access preamble and a predetermined mapping relationship between the random access preamble and the resource block, performs channel estimation on a signal at the resource position based on the pilot signal, and detects the data based on a result of the channel estimation.

In another implementation, a symbol length and/or a cyclic prefix in the resource block are/is greater than predefined values/a predefined value.

In this implementation, the base station performs blind detection on user activities in predetermined resource blocks, and performs channel estimation on a signal at the resource position based on the pilot signal, and detects the data based on a result of the channel estimation.

It can be seen from the above embodiment that the base station receives the data information containing the UE ID, performs UE detection and latency estimation to achieve random access of the UE, and obtains the data based on the data information. Hence, random access and data transmission can be achieved in one step, which can both lower signaling overhead and increase the number of accessed UEs.

### Embodiment 3

This embodiment shall be described on the basis of embodiments 1 and 2. An orthogonal preamble sequence is transmitted and orthogonal resource mapping is used in this embodiment.

In this embodiment, it is assumed that the data to be transmitted of the UE are of 20 bytes, i.e. 160 bits, the UE ID is of 40 bits, the pilot signal is of 8 bits, quadrature amplitude modulation (QAM) and a ½ code rate are used, and a multicarrier modulation technique of the f-OFDM is adopted to transmit data. Furthermore, the set of orthogonal random access preamble sequences contains M=64 ZC sequences of each having a length of 839 bits, and the random access preamble sequences are numbered from 1 to 64.

It is assumed that the preamble sequences of a length of 839 bits occupy N_{f,p}=4 subcarriers in the frequency domain and N_{t,p}=210 symbols in the time domain; and the data to be transmitted of the UE occupy N_{f,d}=8 subcarriers in the frequency domain and N_{t,d}=26 symbols in the time domain, that is, sizes of resource blocks applicable to the mMTC (mRBs) are 8 subcarriers multiplied by 26 symbols.

Hence, within the N_{t,p}=210 symbols occupied by the preamble sequence, the N_{f,d}=8 subcarriers may carry Kₜ=8 UEs. And ½k_{f} N_{f,d}=32 subcarriers are reserved respectively within upper and lower ranges of the resource occupied by the preamble sequence, hence, within the time frequency resource containing 8*8+4=68 subcarriers at the frequency domain and 210 symbols in the time domain, at most KₜK_{f}=64 UEs may be accommodated at the same time.

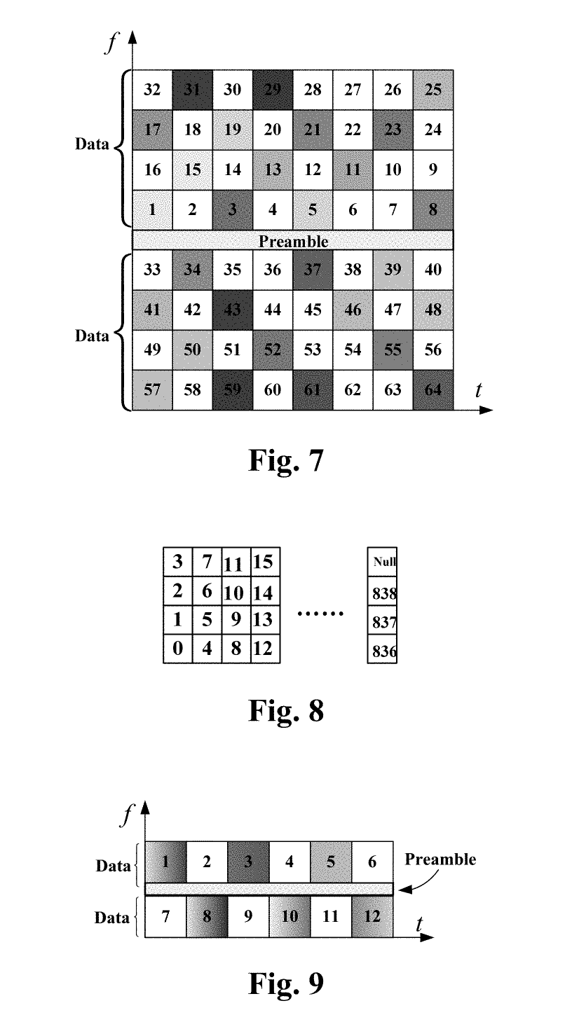

FIG. 7 is a schematic diagram of a frame structure using an orthogonal preamble sequence and orthogonal resource mapping of the embodiment of this disclosure, and FIG. 8 is a schematic diagram of time frequency resource mapping of the preamble sequence of the embodiment of this disclosure. As shown in FIGS. 7 and 8, the above mRBs may be numbered; for example, an mRB numbered i corresponds to a preamble sequence numbered i.

In this embodiment, the UE may randomly select a preamble sequence pᵢ from the above set of orthogonal random access preamble sequences, transmit the preamble sequence pᵢ on a physical random access channel (PRACH), and transmit the data information on the i-th mRB of a physical uplink shared channel (PUSCH).

The transmitted data information contains a UE ID, a pilot signal and payload. And the following mode may be used by the pilot signal: randomly selecting a pilot position and randomly selecting a pilot sequence from a pre-agreed pilot position set and pilot sequence set.

In this embodiment, the base station may perform UE detection and latency estimation (i.e. synchronization) according to the received random access preamble sequence. And as the random access preamble sequence is spread on two dimensions of time and frequency, the base station needs to perform phase compensation in performing the latency estimation.

For example, as shown in FIG. 8, the random access preamble sequence is mapped according to the frequency dimension and then according to the time dimension, hence, a phase difference between an i-th column and an (i+1)-th column is e^{j2π4Δfτ}; where, Δf is a subcarrier spacing in the adopted f-OFDM multicarrier transmission, and τ is latency of the UE. Thus, in performing the latency estimation, corresponding phase compensation needs to be performed on a received signal according to columns, and then which preamble sequences are transmitted is detected by using relevant detection and corresponding latency is obtained.

Thereafter, the base station may perform data demodulation on corresponding resources according to the detected preamble sequences and estimated latency. For example, following may be particularly included: performing channel estimation at all possible pilot positions according to all possible pilot sequences, and if differences between amplitudes in the frequency domain of channel estimation results obtained at different positions are not large and sparsity specific to channels presents in the time domain, it may be determined that a UE transmits data information at the pilot position and the pilot sequence; otherwise, it is deemed that data information is not transmitted by a UE at the pilot position and the pilot sequence.

Then, the base station may demodulate the UE ID and the payload according to channel estimation results.

In this embodiment, after successfully demodulating the data of the UE, the base station may transmit the ACK message to the UE. And if the UE does not receive the ACK message within a predefined time from the base station, it may be randomly back off for a period of time, and then retransmit the data information.

It should be noted that this disclosure is illustrated above by way of particular examples; however, this disclosure is not limited thereto. For example, the above parameters may be appropriately modified, etc.

### Embodiment 4

This embodiment shall be described on the basis of embodiments 1 and 2. An orthogonal preamble sequence is transmitted and nonorthogonal resource mapping is used in this embodiment.

In this embodiment, it is assumed that the data to be transmitted of the UE are of 20 bytes, i.e. 160 bits, the UE ID is of 40 bits, the pilot signal is of 8 bits, QAM and a ½ code rate are used, and a multicarrier modulation technique of the f-OFDM is adopted to transmit data. Furthermore, the set of orthogonal random access preamble sequences contains M=24 ZC sequences of each having a length of 311 bits, and the preamble sequences are numbered from 1 to 24.

Furthermore, such as columns in a 12×24 low-density parity check (LDPC) sparse generation matrix may be taken as sparsely-spread codewords, that is, there are totally twenty-four 12×1 sparse codewords, which are numbered from 1 to 24. A progressive edge-growth algorithm (PEG), for example, may be referred to for generating the LDPC sparse generation matrix, which shall not be described herein any further.

In this embodiment, it is assumed that the preamble sequences of a length of 311 bits occupy N_{f,p}=2 subcarriers in the frequency domain and N_{t,p}=156 symbols in the time domain; and the data to be transmitted of the UE occupy N_{f,d}=8 subcarriers in the frequency domain and N_{t,d}=26 symbols in the time domain, that is, sizes of resource blocks applicable to the mMTC (mRBs) are 8 subcarriers multiplied by 26 symbols.

Hence, within the N_{t,p}=156 symbols occupied by the preamble sequence, the N_{f,d}=8 subcarriers may carry Kₜ=6 UEs. And ½k_{f}N_{f,d}=8 subcarriers are reserved respectively within upper and lower ranges of the resource occupied by the preamble sequence, hence, within the time frequency resource containing 2*8+2=18 subcarriers at the frequency domain and 156 symbols in the time domain, the above 12×24 sparse generation matrix is used, and at most 2*KₜK_{f}=24 UEs may be accommodated at the same time.

FIG. 9 is a schematic diagram of a frame structure using an orthogonal preamble sequence and nonorthogonal resource mapping of the embodiment of this disclosure. As shown in FIG. 9, the above mRBs may be numbered, the numbers corresponding respectively to each element in 12×1 sparse codewords.

In this embodiment, the UE may randomly select a preamble sequence pᵢ from the above set of orthogonal random access preamble sequences, transmit the preamble sequence pᵢ on a physical random access channel (PRACH), and spread the data information onto the 12 mRBs on a physical uplink shared channel (PUSCH) by using an i-th sparse codeword.

The transmitted data information contains a UE ID, a pilot signal and payload. And the following mode may be used by the pilot signal: a fixed pilot position and a fixed pilot sequence.

In this embodiment, the base station may perform UE detection and latency estimation (i.e. synchronization) according to the received random access preamble sequence. And as the random access preamble sequence is spread on two dimensions of time and frequency, the base station needs to perform phase compensation in performing the latency estimation.

For example, as shown in FIG. 8, the random access preamble sequence is mapped according to the frequency dimension and then according to the time dimension, hence, a phase difference between an i-th column and an (i+1)-th column is e^{j2π2Δfτ}; where, Δf is a subcarrier spacing in the adopted f-OFDM multicarrier transmission, and τ is latency of the UE. Thus, in performing the latency estimation, corresponding phase compensation needs to be performed on a received signal according to columns, and then which preamble sequences are transmitted is detected by using relevant detection and corresponding latency is obtained.

Thereafter, the base station may perform channel estimation according to the pilot signal, and perform data demodulation for the above sparse spreading by using, for example, a message passing algorithm (MPA), so as to obtain the UE ID and the payload.

In this embodiment, after successfully demodulating the data of the UE, the base station may transmit the ACK message to the UE. And if the UE does not receive the ACK message within a predefined time from the base station, it may be randomly back off for a period of time, and then retransmit the data information in the above manner.

It should be noted that this disclosure is illustrated above by way of particular examples; however, this disclosure is not limited thereto. For example, the above parameters may be appropriately modified, etc.

### Embodiment 5

This embodiment shall be described on the basis of embodiments 1 and 2. A nonorthogonal preamble sequence is transmitted and orthogonal resource mapping is used in this embodiment.

In this embodiment, it is assumed that the data to be transmitted of the UE are of 20 bytes, i.e. 160 bits, the UE ID is of 40 bits, the pilot signal is of 8 bits, QAM and a ½ code rate are used, and a multicarrier modulation technique of the f-OFDM is adopted to transmit data. The set of nonorthogonal random access preamble sequences is, for example, constituted by two sets of orthogonal random access preamble sequences independent of each other, in which each set of orthogonal random access preamble sequences contains M=6 ZC sequences of each having a length of 73 bits, which are respectively denoted by 1×73 vectors pᵢ¹ and pⱼ²; where, i,j=1,L, 6.

A preamble sequence may be randomly selected respectively from the two sets of orthogonal random access preamble sequences independent of each other. The two preamble sequences jointly identify a UE, hence, total 6²=36 UEs may be identified. And the above 36 preamble sequences may be denoted by pₖ′=[pᵢ¹,pⱼ²] in a combined manner; where, k=1,L,36.

In this embodiment, a preamble sequence of a length of 73 bits from one set of orthogonal random access preamble sequences may be added with 0 subsequent to it and then mapped onto a time frequency resource occupying N_{f,p}=1 subcarrier in the frequency domain and N_{t,p}=78 symbols in the time domain; and a preamble sequence of a length of 73 bits from the other set of orthogonal random access preamble sequences may be added with 0 subsequent to it and then mapped onto a time frequency resource occupying N_{f,p}=1 subcarrier in the frequency domain and N_{t,p}=78 symbols in the time domain. And the data to be transmitted of the UE occupy N_{f,d}=8 subcarriers in the frequency domain and N_{t,p}=26 symbols in the time domain, that is, sizes of resource blocks applicable to the mMTC (mRBs) are 8 subcarriers multiplied by 26 symbols.

Hence, within the N_{t,p}=78 symbols occupied by the preamble sequence, the N_{f,d}=8 subcarriers may carry Kₜ=83 UEs. And ½k_{f}N_{f,d}=48 subcarriers are reserved respectively within upper and lower ranges of the resource occupied by the preamble sequence, hence, within the time frequency resource containing 12*8+2=98 subcarriers at the frequency domain and 78 symbols in the time domain, at most KₜK_{f}=36 UEs may be accommodated at the same time.

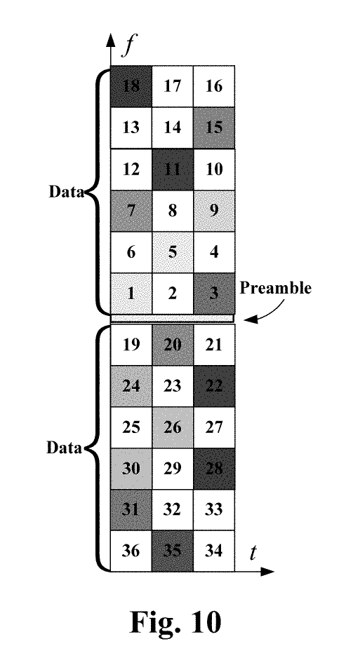

FIG. 10 is a schematic diagram of a frame structure using a nonorthogonal preamble sequence and orthogonal resource mapping of the embodiment of this disclosure. As shown in FIG. 10, the above mRBs may be numbered; an mRB numbered i corresponds to a preamble sequence combination numbered i.

In this embodiment, the UE may randomly select a preamble sequence pᵢ′ from the above 36 orthogonal random access preamble sequence combinations, transmit the preamble sequence pᵢ′ on a physical random access channel (PRACH), and transmit the data information on an i-th mRB of a physical uplink shared channel (PUSCH).

The transmitted data information contains a UE ID, a pilot signal and payload. And the following mode may be used by the pilot signal: a fixed pilot position and a fixed pilot sequence.

In this embodiment, the base station may perform UE detection and latency estimation (i.e. synchronization) according to the received random access preamble sequence. In particular, corresponding detection is respectively performed on the above random access preamble sequences pᵢ¹ and pⱼ² mapped onto two subcarriers to obtain corresponding latency; and if pᵢ¹ and pⱼ² have the same latency, it is deemed that the two sequences are from the same UE.

Then the base station may perform data demodulation on corresponding resources according to the detected preamble sequences and the estimated latency. For example, it may particularly include: performing channel estimation according to the pilot signal, and demodulating the UE ID and the payload according to a result of the channel estimation.

In this embodiment, after successfully demodulating the data of the UE, the base station may transmit the ACK message to the UE. And if the UE does not receive the ACK message within a predefined time from the base station, it may be randomly back off for a period of time, and then retransmit the data information in the above manner.

It should be noted that this disclosure is illustrated above by way of particular examples; however, this disclosure is not limited thereto. For example, the above parameters may be appropriately modified, etc.

### Embodiment 6

This embodiment shall be described on the basis of embodiments 1 and 2. A nonorthogonal preamble sequence is transmitted and nonorthogonal resource mapping is used in this embodiment.

In this embodiment, it is assumed that the data to be transmitted of the UE are of 20 bytes, i.e. 160 bits, the UE ID is of 40 bits, the pilot signal is of 8 bits, QAM and a ½ code rate are used, and a multicarrier modulation technique of the f-OFDM is adopted to transmit data. The set of nonorthogonal random access preamble sequences is, for example, constituted by two sets of orthogonal random access preamble sequences independent of each other, in which each set of orthogonal random access preamble sequences contains M=6 ZC sequences of each having a length of 73 bits, which are respectively denoted by 1×73 vectors pᵢ¹ and pⱼ²; where, j=1,L,6.

A preamble sequence may be randomly selected respectively from the two sets of orthogonal random access preamble sequences independent of each other. The two preamble sequences jointly identify a UE, hence, total 6²=36 UEs may be identified. And the above 36 preamble sequences may be denoted by pₖ′=[pᵢ¹,pⱼ²] in a combined manner; where, k=1,L,36.

Furthermore, columns in a 18×36 LDPC sparse generation matrix, for example, may be taken as sparsely-spread codewords, that is, there are totally thirty-six 18×1 sparse codewords, which are numbered from 1 to 36. A PEG algorithm, for example, may be referred to for a method for generating the LDPC sparse generation matrix, which shall not be described herein any further.

In this embodiment, a preamble sequence of a length of 73 bits from one set of orthogonal random access preamble sequences may be added with 0 subsequent to it and then mapped onto a time frequency resource occupying N_{f,p}=1 subcarrier in the frequency domain and N_{t,p}=78 symbols in the time domain; and a preamble sequence of a length of 73 bits from the other set of orthogonal random access preamble sequences may be added with 0 subsequent to it and then mapped onto a time frequency resource occupying N_{f,p}=1 subcarrier in the frequency domain and N_{t,p}=78 symbols in the time domain. And the data to be transmitted of the UE occupy N_{f,d}=8 subcarriers in the frequency domain and N_{t,p}=26 symbols in the time domain, that is, sizes of resource blocks applicable to the mMTC (mRBs) are 8 subcarriers multiplied by 26 symbols.

Hence, within the N_{t,p}=78 symbols occupied by the preamble sequence, the N_{f,d}=8 subcarriers may carry Kₜ=3 UEs. And ½k_{f}N_{f,d}=24 subcarriers are reserved respectively within upper and lower ranges of the resource occupied by the preamble sequence, hence, within the time frequency resource containing 6*8+2=50 subcarriers at the frequency domain and 78 symbols in the time domain, at most 2KₜK_{f}=36 UEs may be accommodated at the same time.

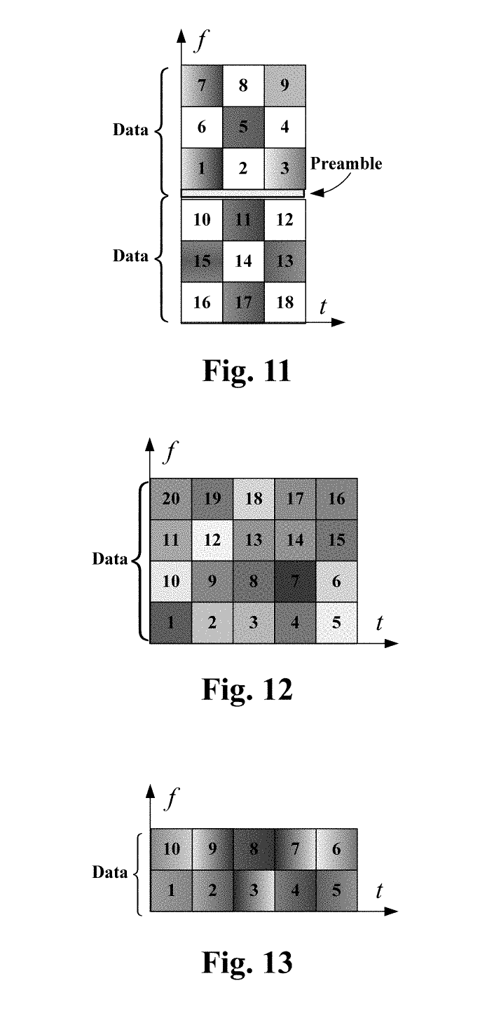

FIG. 11 is a schematic diagram of a frame structure using a nonorthogonal preamble sequence and nonorthogonal resource mapping of the embodiment of this disclosure. As shown in FIG. 11, the above mRBs may be numbered, the numbers corresponding respectively to each element in 18×1 sparse codewords.

In this embodiment, the UE may randomly select a preamble sequence pᵢ′ from the above 36 orthogonal random access preamble sequence combinations, transmit the preamble sequence pᵢ′ on a physical random access channel (PRACH), and spread the data information onto the 18 mRBs on a physical uplink shared channel (PUSCH) by using an i-th sparse codeword.

The transmitted data information contains a UE ID, a pilot signal and payload. And the following mode may be used by the pilot signal: a fixed pilot position and a fixed pilot sequence.

In this embodiment, the base station may perform UE detection and latency estimation (i.e. synchronization) according to the received random access preamble sequence. In particular, corresponding detection is respectively performed on the above random access preamble sequences pᵢ¹ and pⱼ² mapped onto two subcarriers to obtain corresponding latency; and if pᵢ¹ and pⱼ² have the same latency, it is deemed that the two sequences are from the same UE.

Then the base station may perform channel estimation according to the pilot signal, and perform data demodulation for the above sparse spreading by using, for example, an MPA algorithm, so as to obtain the UE ID and the payload.

In this embodiment, after successfully demodulating the data of the UE, the base station may transmit the ACK message to the UE. And if the UE does not receive the ACK message within a predefined time from the base station, it may be randomly back off for a period of time, and then retransmit the data information in the above manner.

It should be noted that this disclosure is illustrated above by way of particular examples; however, this disclosure is not limited thereto. For example, the above parameters may be appropriately modified, etc.

### Embodiment 7

This embodiment shall be described on the basis of embodiments 1 and 2. A preamble sequence is not transmitted and orthogonal resource mapping is used in this embodiment.

In this embodiment, it is assumed that the data to be transmitted of the UE are of 20 bytes, i.e. 160 bits, the UE ID is of 40 bits, the pilot signal is of 8 bits, and QAM and a ½ code rate are used.

It is assumed that the data to be transmitted of the UE occupy N_{f,d}=8 subcarriers in the frequency domain and N_{t,p}=26 symbols in the time domain, that is, sizes of resource blocks applicable to the mMTC (mRBs) are 8 subcarriers multiplied by 26 symbols.

FIG. 12 is a schematic diagram of a frame structure not using a preamble sequence and using orthogonal resource mapping of the embodiment of this disclosure. As shown in FIG. 12, there are total 20 mRBs in a range of a time frequency resource having 150 symbols at the time dimension and 32 subcarriers at the frequency dimension. As shown in FIG. 12, the above mRBs may be numbered.

In this embodiment, the UE may transmit the data information on an i-th mRB randomly selected at a physical uplink shared channel (PUSCH); the transmitted data information contains a UE ID, a pilot signal and payload, and the pilot signal may adopt a fixed pilot position and a fixed pilot sequence.

Furthermore, the UE may transmit the data information by using the OFDM technique, each symbol containing a very long cyclic prefix (CP). Furthermore, a guard interval (GT) may be added to a rear end of a symbol temporally neighboring a next mRB, which is used to reduce inter-UE interference on the neighboring mRB resulted from asynchronization.

In this embodiment, for each mRB, the base station may perform data demodulation within a predetermined observation time window, and perform UE detection according to a result of the data demodulation, that is, performing channel estimation first according to the pilot signal, and then demodulating the UE ID and the payload according to a result of the channel estimation.

In this embodiment, after successfully demodulating the data of the UE, the base station may transmit the ACK message to the UE. And if the UE does not receive the ACK message within a predefined time from the base station, it may be randomly back off for a period of time, and then retransmit the data information in the above manner.

It should be noted that this disclosure is illustrated above by way of particular examples; however, this disclosure is not limited thereto. For example, the above parameters may be appropriately modified, etc.

### Embodiment 8

This embodiment shall be described on the basis of embodiments 1 and 2. A preamble sequence is not transmitted and nonorthogonal resource mapping is used in this embodiment.

In this embodiment, it is assumed that the data to be transmitted of the UE are of 20 bytes, i.e. 160 bits, the UE ID is of 40 bits, the pilot signal is of 8 bits, and QAM and a ½ code rate are used.

Furthermore, columns in a 10×20 LDPC sparse generation matrix, for example, may be taken as sparsely-spread codewords, that is, there are totally twenty 10×1 sparse codewords, which are numbered from 1 to 20. A PEG algorithm, for example, may be referred to for a method for generating the LDPC sparse generation matrix, which shall not be described herein any further.

In this embodiment, the data to be transmitted of the UE occupy N_{f,d}=8 subcarriers in the frequency domain and N_{t,p}=26 symbols in the time domain, that is, sizes of resource blocks applicable to the mMTC (mRBs) are 8 subcarriers multiplied by 26 symbols.

FIG. 13 is a schematic diagram of a frame structure not using a preamble sequence and using nonorthogonal resource mapping of the embodiment of this disclosure. As shown in FIG. 13, there are total 10 mRBs in a range of a time frequency resource having 150 symbols at the time dimension and 16 subcarriers at the frequency dimension. As shown in FIG. 13, the above mRBs may be numbered, the numbers corresponding respectively to each element in 10×1 sparse codewords.

In this embodiment, the UE may randomly select an i-th sparse codeword and spread the data information onto the 10 mRBs on a physical uplink shared channel (PUSCH) by using the sparse codeword; the transmitted data information contains a UE ID, a pilot signal and payload, and the pilot signal may adopt a fixed pilot position and a fixed pilot sequence.

Furthermore, the UE may transmit the data information by using the orthogonal frequency division multiplexing (OFDM) technique, each symbol containing a very long cyclic prefix (CP). Furthermore, a guard interval (GT) may be added to a rear end of a symbol temporally neighboring a next mRB, which is used to reduce inter-UE interference on the neighboring mRB resulted from asynchronization.

In this embodiment, the base station may perform channel estimation according to the pilot signal, and perform data demodulation for the above sparse spreading within a predetermined observation time window by using, for example, an MPA algorithm, so as to obtain the UE ID and the payload.

In this embodiment, after successfully demodulating the data of the UE, the base station may transmit the ACK message to the UE. And if the UE does not receive the ACK message within a predefined time from the base station, it may be randomly back off for a period of time, and then retransmit the data information in the above manner.

It should be noted that this disclosure is illustrated above by way of particular examples; however, this disclosure is not limited thereto. For example, the above parameters may be appropriately modified, etc.

### Embodiment 9

The embodiment of this disclosure provides an apparatus for random access and data transmission, configured in a UE. This embodiment corresponds to the method for random access and data transmission in Embodiment 1, with identical contents being not going to be described herein any further.

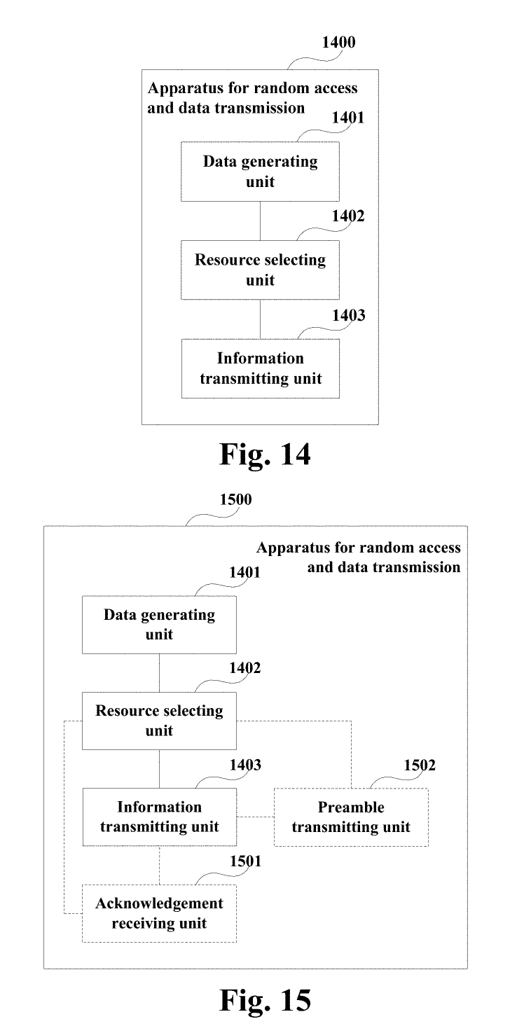

FIG. 14 is a schematic diagram of the apparatus for random access and data transmission of the embodiment of this disclosure. As shown in FIG. 14, the apparatus 1400 for random access and data transmission includes:

a data generating unit 1401 configured to generate data information used for both random access and data transmission, the data information including a UE ID, data to be transmitted and a pilot signal;

a resource selecting unit 1402 configured to select one or more resource blocks for transmitting the data information from predetermined resources; and

an information transmitting unit 1403 configured to map the data information onto the resource blocks and transmit the data information.

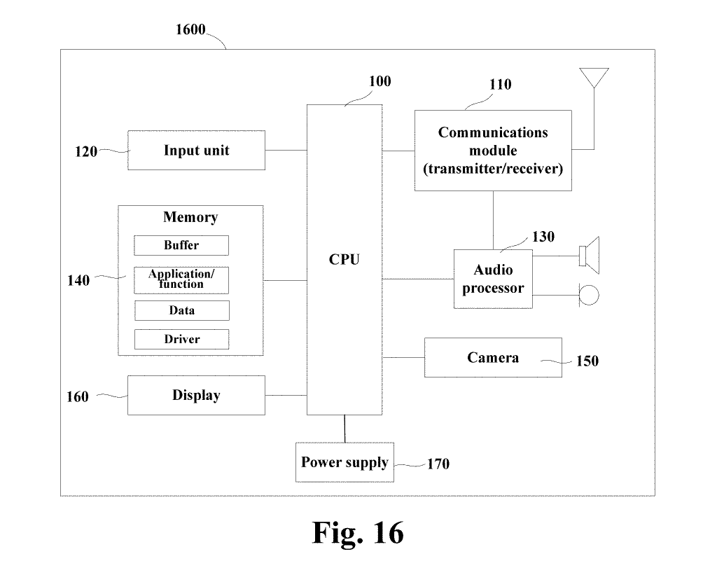

FIG. 15 is another schematic diagram of the apparatus for random access and data transmission of the embodiment of this disclosure. As shown in FIG. 15, the apparatus 1500 for random access and data transmission includes a data generating unit 1401, a resource selecting unit 1402 and an information transmitting unit 1403, as described above.

As shown in FIG. 15, the apparatus 1500 for random access and data transmission may further include:

an acknowledgement receiving unit 1501 configured to receive an acknowledgement message transmitted by the base station.

The resource selecting unit 1402 may further be configured to, in a case where the acknowledgement receiving unit 1501 does not receive the acknowledgement message in a predetermined time, reselect one or more resource blocks for transmitting the data information from the predetermined resources after a period of time of random backoff; and the information transmitting unit 1403 may further be configured to map the data information onto the reselected resource blocks and retransmit the data information.

In one implementation, as shown in FIG. 15, the apparatus 1500 for random access and data transmission may further include:

a preamble transmitting unit 1502 configured to transmit a random access preamble, the random access preamble being used for synchronization and indicating a resource position for transmitting the data information.

In this implementation, random access preambles are mapped to multiple resource blocks; the resource blocks include N_{t,p} symbols in the time domain and N_{f,p} subcarriers in a frequency domain; where, both N_{t,p} and N_{f,p} are positive integers, and N_{t,p} is greater than N_{f,p}.

The random access preambles may be orthogonal to each other; or, the random access preambles may not be orthogonal to each other, and the nonorthogonal random access preambles may be formed by combining multiple orthogonal random access preambles.

In this embodiment, a pilot position and a pilot sequence for the pilot signal may be predetermined; or, the pilot position and the pilot sequence for the pilot signal may not be predetermined, and the data generating unit 1401 may randomly select the pilot position and the pilot sequence for the pilot signal.

In this embodiment, different resource blocks may be orthogonal to each other; or, different resource blocks may not be orthogonal to each other, and data information of different UEs is spread and is distributed in a nonorthogonal sparse mode.

In another implementation, a symbol length and/or a cyclic prefix in the resource block are/is greater than predefined values/a predefined value, so that a base station obtains the transmitted data in predetermined resource blocks by blind detection.

This embodiment further provides a UE, configured with the above-described apparatus 1400 or 1500 for random access and data transmission.

FIG. 16 is a schematic diagram of the UE of the embodiment of this disclosure. As shown in FIG. 16, the UE 1600 may include a central processing unit 100 and a memory 140, the memory 140 being coupled to the central processing unit 100. It should be noted that this figure is illustrative only, and other types of structures may also be used, so as to supplement or replace this structure and achieve a telecommunications function or other functions.

In one implementation, the functions of the apparatus 1400 or 1500 for random access and data transmission may be integrated into the central processing unit 100. The central processing unit 100 may be configured to carry out the method for random access and data transmission described in Embodiment 1.

For example, the central processing unit 100 may be configured to perform the following control: generating data information used for both random access and data transmission by UE, the data information including a UE ID, data to be transmitted and a pilot signal; selecting one or more resource blocks for transmitting the data information by the UE from predetermined resources; and mapping the data information by the UE onto the resource blocks and transmitting the data information.

In another implementation, the apparatus 1400 or 1500 for random access and data transmission and the central processing unit 100 may be configured separately. For example, the apparatus 1400 or 1500 for random access and data transmission may be configured as a chip connected to the central processing unit 100, with its functions being realized under control of the central processing unit 100.

As shown in FIG. 16, the UE 1600 may further include a communication module 110, an input unit 120, an audio processor 130, a memory 140, a camera 150, a display 160 and a power supply 170. Functions of the above components are similar to those in the relevant art, and shall not be described herein any further. It should be noted that the UE 1600 does not necessarily include all the parts shown in FIG. 16, and furthermore, the UE 1600 may include parts not shown in FIG. 16, and the relevant art may be referred to.

It can be seen from the above embodiment that the UE selects one or more resource blocks for transmitting the data information from predetermined resources, and maps the data information containing a UE ID onto the resource blocks and transmits the data information. Hence, random access and data transmission can be achieved in one step, which can both lower signaling overhead and increase the number of accessed UEs.

### Embodiment 10

The embodiment of the present disclosure provides an apparatus for random access and data transmission, configured in a base station. This embodiment corresponds to the method for random access and data transmission in Embodiment 2, with identical contents being not going to be described herein any further.

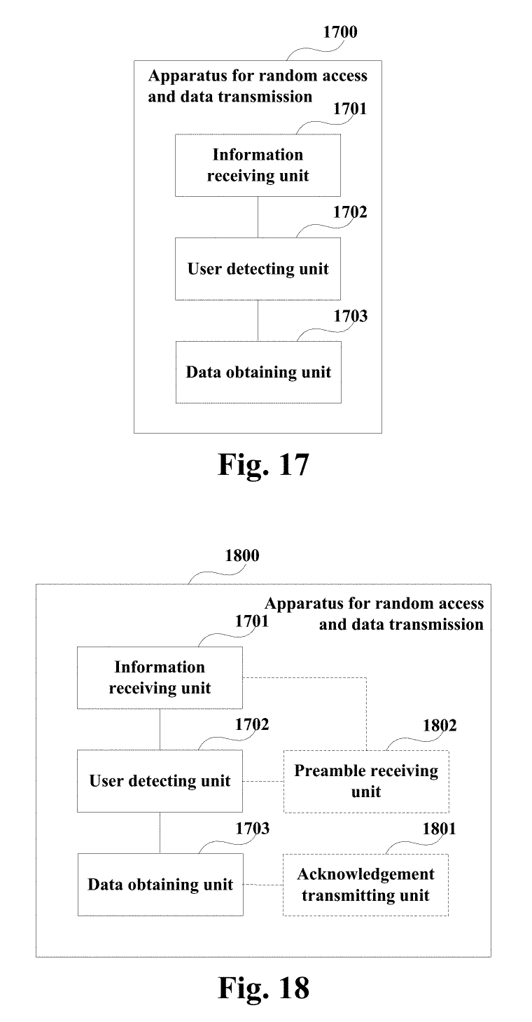

FIG. 17 is a schematic diagram of the apparatus for random access and data transmission of the embodiment of this disclosure. As shown in FIG. 17, the apparatus 1700 for random access and data transmission includes:

an information receiving unit 1701 configured to receive data information used for both random access and data transmission transmitted by a UE, the data information including a UE ID, data to be transmitted and a pilot signal;

a user detecting unit 1702 configured to perform user detection and latency estimation, to achieve random access of the UE; and

a data obtaining unit 1703 configured to obtain the data based on the data information.

FIG. 18 is another schematic diagram of the apparatus for random access and data transmission of the embodiment of this disclosure. As shown in FIG. 18, the apparatus 1800 for random access and data transmission includes an information receiving unit 1701, a user detecting unit 1702 and a data obtaining unit 1703, as described above.

As shown in FIG. 18, the apparatus 1800 for random access and data transmission may further include:

an acknowledgement transmitting unit 1801 configured to transmit an acknowledgement message to the UE when the transmitted data are correctly obtained.

In one implementation, as shown in FIG. 18, the apparatus 1800 for random access and data transmission may further include:

a preamble receiving unit 1802 configured to receive a random access preamble transmitted by the UE, the random access preamble being used for synchronization and indicating a resource position for transmitting the data information.

For example, the data information and the random access preambles of multiple UEs occupy the same symbols in a time domain. And furthermore, random access preambles are mapped to multiple resource blocks; the resource blocks include N_{t,p} symbols in the time domain and N_{f,p} subcarriers in a frequency domain; where, both N_{t,p} and N_{f,p} are positive integers, and N_{t,p} is greater than N_{f,p}.

In this implementation, the user detecting unit 1702 may be configured to: perform user detection and latency estimation according to the random access preamble; and the data obtaining unit 1703 may be configured to: obtain a resource position of the UE for transmitting the data information based on the detected random access preamble and a predetermined mapping relationship between the random access preamble and the resource block, perform channel estimation on a signal at the resource position based on the pilot signal, and detect the data based on a result of the channel estimation.

In another implementation, a symbol length and/or a cyclic prefix in the resource block are/is greater than predefined values/a predefined value.

In this implementation, the user detecting unit 1702 may be configured to: perform blind detection on user activities in predetermined resource blocks; and the data obtaining unit 1703 may be configured to: perform channel estimation on a signal at the resource position based on the pilot signal, and detect the data based on a result of the channel estimation.

The embodiment of this disclosure further provides a base station, configured with the above-described apparatus 1700 or 1800 for random access and data transmission.

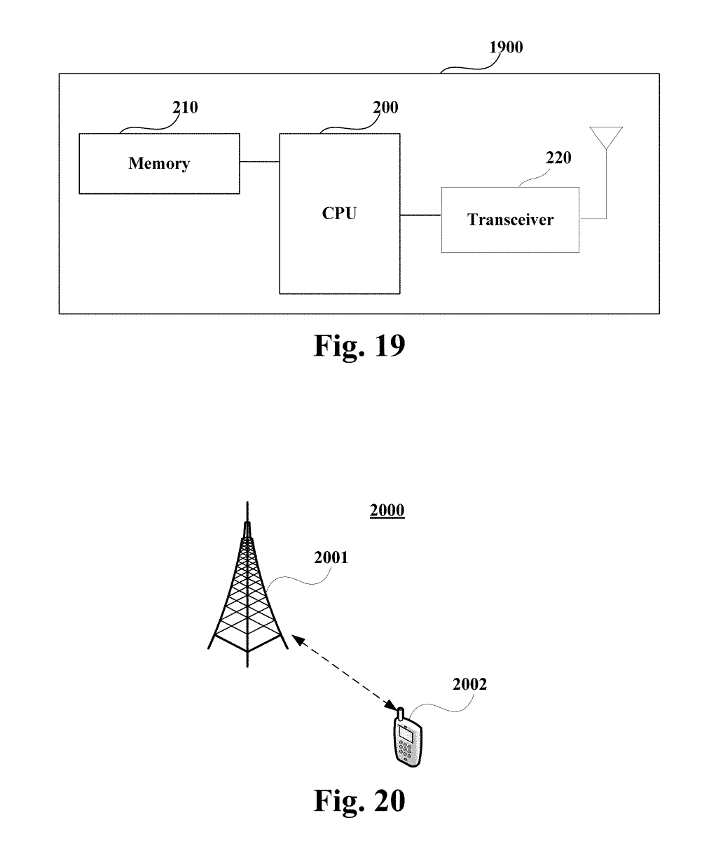

FIG. 19 is a schematic diagram of the base station of the embodiment of this disclosure. As shown in FGI. 19, the base station 1900 may include a central processing unit (CPU) 200 and a memory 210, the memory 210 being coupled to the central processing unit 200. The memory 210 may store various data, and furthermore, it may store a program for information processing, and execute the program under control of the central processing unit 200.

The apparatus 1700 or 1800 for random access and data transmission may carry out the method for random access and data transmission described in Embodiment 2. And the central processing unit 200 may be configured to carry out the functions of the apparatus 1700 or 1800 for random access and data transmission.

For example, the central processing unit 200 may be configured to perform the following control: receiving data information used for both random access and data transmission transmitted by a UE, the data information including a UE ID, data to be transmitted and a pilot signal; performing user detection and latency estimation, to achieve random access of the UE; and obtaining the data based on the data information.

Furthermore, as shown in FIG. 19, the base station 1900 may include a transceiver 220, and an antenna 230, etc. Functions of the above components are similar to those in the relevant art, and shall not be described herein any further. It should be noted that the base station 1900 does not necessarily include all the parts shown in FIG. 19, and furthermore, the base station 1900 may include parts not shown in FIG. 19, and the relevant art may be referred to.

It can be seen from the above embodiment that the base station receives the data information containing the UE ID, performs user detection and latency estimation, so as to achieve random access of the UE, and obtains the data based on the data information. Hence, random access and data transmission can be achieved in one step, which can both lower signaling overhead and increase the number of accessed UEs.

### Embodiment 11

The embodiment of the present disclosure provides a communication system, with contents identical to those in embodiments 1-10 being not going to be described herein any further.

FIG. 20 is a schematic diagram of the communication system of the embodiment of this disclosure. As shown in FIG. 20, the communication system 2000 may include a base station 2001 and a UE 2002.

The UE 2002 generates data information used for both random access and data transmission, the data information including a UE ID, data to be transmitted and a pilot signal, selects one or more resource blocks for transmitting the data information from predetermined resources, and maps the data information into the resource blocks and transmit the data information;

and the base station 2001 receives the data information transmitted by the UE, performs user detection and latency estimation so as to achieve random access of the UE, and obtains the data based on the data information.

An embodiment of the present disclosure provides a computer readable program, which, when executed in a UE, will cause a computer to carry out the method for random access and data transmission described in Embodiment 1 in the UE.

An embodiment of the present disclosure provides a computer storage medium, including a computer readable program, which will cause a computer to carry out the method for random access and data transmission described in Embodiment 1 in a UE.

An embodiment of the present disclosure provides a computer readable program, which, when executed in a base station, will cause a computer to carry out the method for random access and data transmission described in Embodiment 2 in the base station.

An embodiment of the present disclosure provides a computer storage medium, including a computer readable program, which will cause a computer to carry out the method for random access and data transmission described in Embodiment 2 in a base station.

The above apparatuses of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The method for random access and data transmission carried out in the apparatus for random access and data transmission described with reference to the embodiments of this disclosure may be directly embodied as hardware, software modules executed by a processor, or a combination thereof. For example, one or more functional block diagrams and/or one or more combinations of the functional block diagrams shown in FIG. 13 (such as the information transmitting unit, etc.) may either correspond to software modules of procedures of a computer program, or correspond to hardware modules. Such software modules may respectively correspond to the steps shown in FIG. 2. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

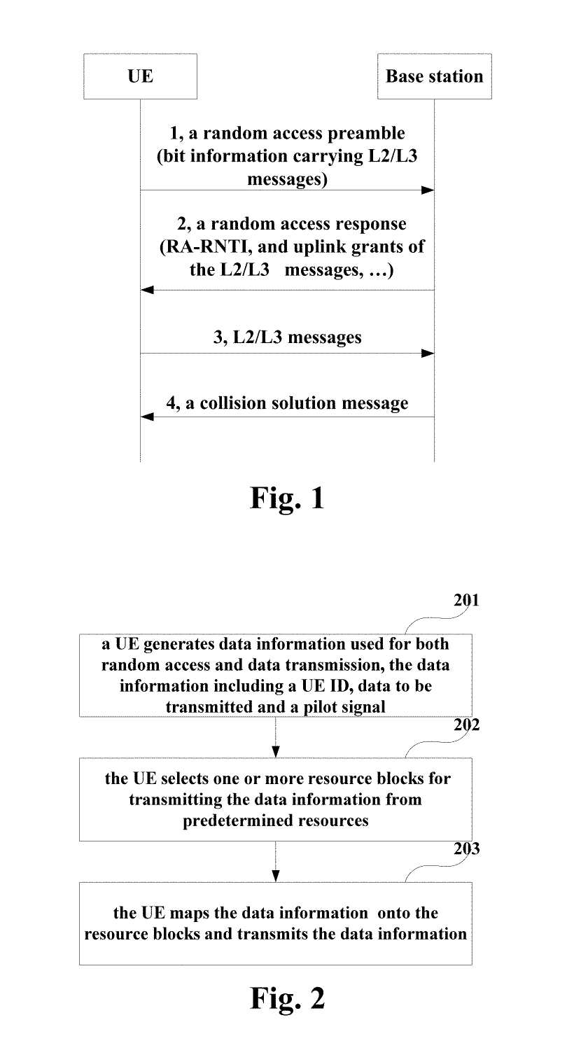

One or more functional blocks and/or one or more combinations of the functional blocks in FIG. 1 may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in FIG. 1 may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

What is claimed is:

1. An apparatus for random access and data transmission, configured in a user equipment (UE), the apparatus comprising:
a data generating unit configured to generate data information used for both random access and data transmission, the data information comprising a UE ID, data to be transmitted and a pilot signal;
a resource selecting unit configured to select one or more resource blocks for transmitting the data information from predetermined resources; and
an information transmitting unit configured to map the data information onto the resource blocks and transmit the data information.

2. The apparatus according to claim 1, wherein the apparatus further comprises:
a preamble transmitting unit configured to transmit a random access preamble, the random access preamble being used for synchronization and indicating a resource position for transmitting the data information.

3. The apparatus according to claim 2, wherein the data information and the random access preambles of multiple UEs occupy the same symbols in a time domain.

4. The apparatus according to claim 2, wherein random access preambles are mapped to multiple resource blocks; the resource blocks comprise N_{t,p} symbols in a time domain and N_{f,p} subcarriers in a frequency domain; where, both N_{t,p} and N_{f,p} are positive integers, and N_{t,p} is greater than N_{f,p}.

5. The apparatus according to claim 2, wherein random access preambles are orthogonal to each other;
or, the random access preambles are not orthogonal to each other, and the nonorthogonal random access preambles are formed by combining multiple orthogonal random access preambles.

6. The apparatus according to claim 1, wherein a pilot position and a pilot sequence for the pilot signal are predetermined;
or, the pilot position and the pilot sequence for the pilot signal are not predetermined, and the data generating unit is configured to randomly select the pilot position and the pilot sequence of the pilot signal.

7. The apparatus according to claim 1, wherein different resource blocks are orthogonal to each other;
or, different resource blocks are not orthogonal to each other, and data information of different UEs is spread and is distributed in a nonorthogonal sparse mode.

8. The apparatus according to claim 1, wherein a symbol length and/or a cyclic prefix in the resource block are/is greater than predefined values/a predefined value, and a base station obtains the transmitted data in predetermined resource blocks by blind detection.

9. The apparatus according to claim 1, wherein the apparatus further comprises:
an acknowledgement receiving unit configured to receive an acknowledgement message transmitted by a base station.

10. The apparatus according to claim 9, wherein the resource selecting unit is further configured to, in a case where the acknowledgement receiving unit does not receive the acknowledgement message in a predetermined time, reselect one or more resource blocks for transmitting the data information from the predetermined resources after a period of time of random backoff;
and the information transmitting unit is further configured to map the data information onto the reselected resource blocks and retransmit the data information.

11. An apparatus for random access and data transmission, configured in a base station, the apparatus comprising:
an information receiving unit configured to receive data information used for both random access and data transmission transmitted by a UE, the data information comprising a UE ID, data to be transmitted and a pilot signal;
a user detecting unit configured to perform user detection and latency estimation, to achieve random access of the UE; and
a data obtaining unit configured to obtain the data based on the data information.

12. The apparatus according to claim 11, wherein the apparatus further comprises:
a preamble receiving unit configured to receive a random access preamble transmitted by the UE, the random access preamble being used for synchronization and indicating a resource position for transmitting the data information.

13. The apparatus according to claim 12, wherein the data information and the random access preambles of multiple UEs occupy the same symbols in a time domain.

14. The apparatus according to claim 12, wherein random access preambles are mapped to multiple resource blocks; the resource blocks comprise N_{t,p} symbols in the time domain and N_{f,p} subcarriers in a frequency domain; where, both N_{t,p} and N_{f,p} are positive integers, and N_{t,p} is greater than N_{f,p}.

15. The apparatus according to claim 12, wherein the user detecting unit is configured to: perform user detection and latency estimation according to the random access preamble;
and the data obtaining unit is configured to: obtain a resource position of the UE for transmitting the data information based on the detected random access preamble and a predetermined mapping relationship between the random access preamble and the resource block, perform channel estimation on a signal at the resource position based on the pilot signal, and detect the data based on a result of the channel estimation.

16. The apparatus according to claim 11, wherein a symbol length and/or a cyclic prefix in the resource block are/is greater than predefined values/a predefined value.

17. The apparatus according to claim 16, wherein the user detecting unit is configured to:
perform blind detection on user activities in predetermined resource blocks;
and the data obtaining unit is configured to: perform channel estimation on a signal at the resource position based on the pilot signal, and detect the data based on a result of the channel estimation.

18. The apparatus according to claim 11, wherein the apparatus further comprises:
an acknowledgement transmitting unit configured to transmit an acknowledgement message to the UE when the transmitted data are correctly obtained.

19. A communication system, comprising:
a UE configured to generate data information used for both random access and data transmission, the data information comprising a UE ID, data to be transmitted and a pilot signal, select one or more resource blocks for transmitting the data information from predetermined resources, and map the data information into the resource blocks and transmit the data information; and
a base station configured to receive the data information transmitted by the UE, perform user detection and latency estimation to achieve random access of the UE, and obtain the data based on the data information.
